(19) United States
(12) Patent Application Publication
(10) Pub. No.: US 2014/0278552 A1
(43) Pub. Date: Sep. 18, 2014

(54) MODULAR CENTRALIZED PATIENT MONITORING SYSTEM

(71) Applicant: GLOBAL TELEHEALTH SOLUTIONS, INC., HOLLYWOOD, FL (US)

(72) Inventor: David Hold, Aventura, FL (US)

(21) Appl. No.: 14/211,251

(22) Filed: Mar. 14, 2014

Related U.S. Application Data
(60) Provisional application No. 61/929,157, filed on Jan. 20, 2014.
(60) Provisional application No. 61/788,804, filed on Mar. 15, 2013.

(51) Int. Cl. G06F 19/00

(52) U.S. Cl. CPC G06F 19/3418; G06F 19/322
USPC 705/3

(57) ABSTRACT

A system for monitoring patients includes an automated computer based platform communicating with a plurality of monitoring devices. The monitoring devices are provided to a plurality of patients. The information from the monitoring devices is analyzed automatically and if parameters, such weight, glucose level, EKG, etc. are found to be abnormal, an alert is sent to the physician in charge of the respective patient. The physician can then access a data site providing him with more complete information about the patient.

### RELATED APPLICATIONS

This application claims priority to U.S. Provisional Patent Application Ser. No. 61/788,804 filed Mar. 15, 2013 and U.S. Provisional Patent Application Ser. No. 61/929,157 filed Jan. 20, 2014. The subject matter of this application is also related to application Ser. No. 13/004,267 filed Jan. 11, 2011, entitled Method and Apparatus for Monitoring Medication Intake by Patients, now-______; Ser. No. 13/075,712 filed Mar. 30, 2011 entitled System for Storing and Disseminating Patient Data and Related Information now-______; and Ser. No. 13/033,116 filed Feb. 23, 2011, entitled Method and Apparatus for Monitoring Diabetic Patients. All applications identified hereinabove are incorporated herein by reference in their entirety.

### BACKGROUND OF THE INVENTION

A. Field of Invention

This invention presents a comprehensive fully automated platform servicing a plurality of patients, each patient being associated with one or more monitor devices. A primary physician is associated with each patient and provides the patient with the respective monitor devices. The primary physician also sets up each monitor device and sets certain operational parameters, including ranges, thresholds and/or other limiting values for some of the patients' critical biological functions, as well as certain operational rules for a platform communicating with the monitor devices, as well as the primary physician, patient care takers and other entities. These rules and parameters define abnormal conditions for the patients and when such conditions are detected, the patient platform sends appropriate alerts to the respective primary physician, patient care taker and/or other personnel, such as emergency services and other first responding entities.

B. Description of the Prior Art

The purpose of the invention is to address a major problem in the healthcare system today: the ability for a physician to remotely monitor certain crucial parameters of patients. Providing physicians with such a capability is especially important for monitoring clinically ID patients, especially between office visits, to avoid frequent emergency room visits as well as hospitalizations and frequent readmissions so common with such patients. Critically ill patients that will benefit from the system include patients with diagnoses such congestive heart failure, diabetics, renal failure, just to name a few. The ability of physicians to receive relevant patient vital parameters frequently enough to avoid the common complications associated with these types of patients is crucial in the physicians ability to adjust the patients plan of care to avoid these complications.

Currently there are many home monitoring devices available to patients to obtain their vital signs and test results such as their daily blood sugar levels, cardiac activity, etc. Although the patient can monitor and test many valuable vital signs using these existing devices, the problem that is not being solved by the existing patients is the process for getting these results to their physicians. Due to the sheer numbers of patients a physician has, makes it impractical to have each patient forward his data daily due to the time it would take to process for the physician to review all the data, and the time it would take to screen out the normal values from the abnormal would be impractical.

The inability of the physician to monitor patients close enough to obtain adequate relevant patient data to better manage their care thereby avoiding patient complications which drive them to the emergency room and often admission to the hospital is. Optimally it would be nice if the physician could see these patients on a daily bases, but this is also impractical, especially if the patient is not ambulatory. Until now there was no realistic way that would allow a physician to monitor his patients in real time and receive only the data relevant to an abnormal condition of the patient, and use this data, if necessary to change the treatment prescribed to the patients.

In the United States new legislation has been recently passed requiring physicians, hospitals, managed care and insurance companies in the future to better monitor these type of patients and thus significantly reduce the incidents of complications resulting in visits to the emergency rooms and hospital admissions and/or re-admissions. Punitive monetary damages can be imposed on these entities if the new requirements of the legislature are not met.

### SUMMARY OF THE INVENTION

This invention pertains to system a central platform receiving data from patient monitoring devices for the purpose of providing a means of monitoring, collecting, evaluation and storing of patient data collected that can be modified or retrieved only on approval of authorized health care providers. The system provides access by a physician to his patient health data in real time by utilizing remote monitoring systems and devices such as, glucose meter, blood pressure, weight scales and other device monitoring.

The system includes a patient monitor platform that is in effect the engine that drives a multilayer operating system, that monitors and communicate with all its standalone monitoring devices, systems and programs. It possesses two way communication capability both managing all peripherals used to remotely monitor, collect, analyzed and store valuable patient health information on a 24/7 and forward crucial monitored information to their physicians who reviews the information and make plan of care decisions and/or changes, to promote the continued health and welfare of their patients and with better close monitoring, avoid common patient complications often resulting in costly frequent patient visits to the emergency room, admissions and/or re-admission. The system is a fully automated functioning independent of human intervention to remotely monitor, collect, receive, store and relay crucial data as desired to the patient's physician. It supports all patient monitoring devices and services communicate with and when determined appropriate, sends on the patient data results to their respective physicians for review.

The platform performs the following function:
1. Registering physician and their patients with the platform, which then establishes both a physician file and patient electronic record file
2. Overseeing the monitoring of the patient by receiving, analyzing, storing and relaying pertinent information to the patients physician. of the monitoring devices
3. Managing monitoring device and other hardware and equipment inventories

For example, the current system provides means for patients to monitor important vital signs such as in the diabetic patient their blood sugar values through the use of a glucometer which the patient uses to test their blood at home and sends the results to the platform. The platform enters the data into the patient record, analyzes the information values and if determined to be an abnormal is forwarded on to the patients physician for review. Other parameters associated with the patient's health are acquired and handled in a similar fashion.

The present system combines aspects of advanced existing monitoring technology, with a novel platform that can effectively detect and monitor a patient's physical state and identification of changes in these physical states are detected which is an essential component of health care management. Current assessment methods often are performed during an office visit and may lead a health care provider to assume observed behaviors represent typical function. Current methods may miss significant acute events or important signals of declining function or may poorly characterize detected events. The present platform is designed for home monitoring and is intended to overcome these limitations.

The present system is an early detection system that captures unusual, irregular, or transitory data or and symptoms and when appropriate relays relevant data to the patent's physician in real time, physician who can than review and make healthcare decisions that assist in maintaining wellness in the patient, avoiding complications which lead to frequent office, emergency room hospitalization, and/or re-hospitalization.

Optimally it would be best for physicians to know all their patients values along with other important information such as weight, blood pressure and so on. However for a physician to review and analyze the sheer amount of data they would have to receive at the offices is practicable.

Inability of a physician to obtain crucial vital signs and other patient health data of their chronically ill patients such as hypertensive in a timely manner to best make plan of care corrections as needed to optimize patient health and decrease the amount of visits to emergency rooms, admissions and re-admissions of diabetic patients who are frequent visitors due to poor compliance or management for various reasons of the diabetes.

Secondly under new Medicare/Medicaid legislation soon to go into effect will impact physicians or hospitals greatly found to inadequately monitor patients like their diabetics close enough to avoid emergency room visits, hospital admissions and re-admissions and if found to fall below what they believe is reasonable patient monitoring can result in punitive monitory damages imposed by Medicare/Medicaid. So it will be very important for the physicians, hospitals and managed care networks provide both a means of adequate patient monitoring but be able to demonstrate their efforts through documentation.

Because of the upcoming new Medicare/Medicaid the need sound documentation of close monitoring efforts by physicians and other health care provider organizations who see these patient, the present system includes modules and the necessary programs to aid in this documentation. The platform monitors, collects and stores all patient monitored information, to include all relayed monitored values to the patients physician and contacts by the physician of reviews of the patient record within the platform assist the provider and/or other care provider networks in meeting documentation necessary to meet

Until now there has been no realistic way for physician to monitoring their Hypertensive Patients in real time, save all the data to an electronic record and receive relevant patient monitored information to identify problems early and head off complications.

Each monitoring devices above is off the shelf FDA approved devices working as per manufactures recommendations. The devices either include already or are modified to include cellular technology, i.e., SLM/SIM, and/or Blue Tooth Technology USB and/or Bluetooth technology built in to the devices which enables each device to communicate with platform.

For example, the cardiac event monitor is preferably an off the shelf unit which is a compatible with the patient monitoring platform. For example, a cardiac monitor device suitable for inclusion into the present system is known as the Aero CT made by TZ Medical, Inc. of Portland Oreg.

The patient monitoring platform may provide real time remote patient monitoring of several devices as well, such as, blood pressure, pulse oxygenation, glucose, weight and so on. The platform is interfaced with the cardiac monitor device to work in unison to provide seamless identification, recording and relaying of certain abnormal cardiac events to the platform. The platform automatically processed the information and sends a report to the physician interface for review and analysis. This is all done without the need for any patient or other personal intervention. The entire process is automated.

A physician interface is implemented using any conventional device that can receive and display information, preferably but not necessarily wirelessly, such as a smart phone, tablet, laptop, desktop, etc.

The patient platform automatically stores information received from the patient monitor devices. The platform further generates from the information ECG graphs in a format familiar to the physician. In one embodiment, the ECG graphs are sent to the physician interface. In another embodiment, a web site is generated with web pages for each patient and/or each physician. The platform then sends a message to the physician using conventional means, such as email, etc., with an imbedded link to the respective webpage. The message may also include a diagnosis generated by the patient monitoring device. The physician can access the respective web page manually or access the web page automatically by activating the link imbedded in the message. Once the webpage is accessed, the physician is presented with information about the patient, patient ID, condition, latest ECG graphs, etc.

Generally speaking the present system provides a reliable system with a reliable diagnostic tool that when worn by a patient, continually monitors the patient's heart rhythm and when abnormal cardiac rhythms are detected, records the event and relays raw data via cell telephone technology built into the unit through a M2M “SIM” card. Once this automated relayed data is received by the monitoring platform which is accomplished without the need of any human interface, the platform identifies the patient assigned to that specific Event Monitor from the information stored in the physician and patient demographic file created at the time of a patient being placed on the monitor relays the event data directly to the physician for review and interpretation. Because this system is fully automated, it does not require any direct action by the patient or other person.

### BRIEF DESCRIPTION OF THE DRAWINGS

FIG. 1 shows a block diagram of a patient monitoring system in accordance with the present invention;

FIG. 2 shows a flow chart of a physician and a patient registering on the platform of FIG. 1;

FIG. 3 shows a flow chart of cardiac signals being captured and processed by the system of FIG. 1;

FIGS. 4A, 4B show two representations of cardiac signals presented to the physician, and FIG. 4C shows a QRS signal presented to the physician;

FIG. 5 shows a flow chart of the medicine management device.

### DESCRIPTION OF THE INVENTION

As shown in FIG. 1, the present invention pertains to a patient monitoring system 10 that includes a patient monitoring platform 12 uses as a primary engine that oversees a plurality monitoring devices associated including a cardiac event monitor 14, a glucose monitor 16 used for diabetic patients, a weight scale 18, a medication management unit 20, an oxygen saturation monitor 22, a blood pressure monitor 24, and/or a PT/NR monitor 26 used for Coumadin treatment, etc.

More specifically, the patient monitoring platform 10 of FIG. 1 is configured to monitor a large number of patients. Each patient is being provided with one or more monitoring devices (e.g., devices 14-26) depending on the specific ailment of each patient, the data requested by the patient's primary physician, etc., as discussed in more detail below. The devices 14-26 are preferably off the shelf FDA approved devices available from various manufacturers, with some minor customization being required with some of these devices in order to insure compatibility with the present system.

Moreover, for the sake of clarity all the devices 14-26 are shown as communicating directly with the platform 12, However, in many instances patients are provided with an intermediate device such as a tablet 30. Of course, other devices may be used as intermediate devices, such as smart phones, desk top or laptop devices, etc. Communications between the monitoring devices 14-26 and the intermediate device 30 is implemented using conventional means, such as a wireless Bluetooth channel. Communications between the monitoring devices 14-26 or intermediate device 30 and the platform 12 are implemented using standard wired or wireless data channels.

Finally, some the monitoring devices, such as the medication management device 20 are implemented by applications installed in the tablet 14.

In some instances the system 10 may take advantage of other means of communications with the patients and/or the physician, such as cell phones 32, land-line phones 34, etc.

In other words, the monitoring devices 14-26 fall into three categories. Some of the devices are self-sufficient stand-alone devices, such as the cardiac monitor 14 that are capable of communicating with the platform 12 directly, for example, by using their own SLM/SIM card that provides them access to a cellular wireless data line.

The second category of devices are devices that communicate with the intermediate device 30 via a wired or wireless connection. The weight scale 18 is one such device.

The third category of devices are not really discrete devices but are described as such for the sake of clarity. These devices, such as the medication management device 20, are implemented as applications on the intermediate device 30. Other monitoring devices falling into this category are pain management,

All the devices can communicate with the patient monitoring platform 12 in real time with little or no patient interaction.

The following tables show some sources for devices used for patient monitoring by the present invention:

### Bluetooth Devices

| | | |
|---|---|---|
| Glucometer | Manufacturer: | New Taipei City, Taiwan |
| Model: TD-4279 | Taidoc | |
| Blood Pressure | Manufacturer: | New Taipei City, Taiwan |
| Model: TD-3128 | Taidoc | |
| Pulse Oximeter | Manufacturer: | New Taipei City, Taiwan |
| Model: TD-8201 | Taidoc | |
| Pulse Oximeter | Manufacturer: | Qinhuangao, Hebei |
| Model: CMS50EW | Contec | Province, China |
| Weight Scale | Manufacturer: | New Taipei City, Taiwan |
| Model: TD-2551 | Taidoc | |
| Ear Thermometer | Manufacturer: | New Taipei City, Taiwan |
| Model: TD-1261 | Taidoc | |

### Wired Devices

| | | |
|---|---|---|
| Glucometer | Manufacturer: | Fort Lauderdale, Florida |
| Model: TRUEresult | Nipro | |
| Blood Pressure | Manufacturer: | Qinhuangao, Hebei |
| Model: contec08c | Contec | Province, China |
| Pulse Oximeter | Manufacturer: | Qinhuangao, Hebei |
| Model: CMS50D+ | Contec | Province, China |

The cardiac monitor is an Aero CT made by TZ Medical, Inc. of Portland Oreg.

These off the shelf monitoring devices present available are all generally designed to interface with a live technician at a remote location. The uniqueness of the present patient monitoring platform is the fact that the latter receives all patient data including the cardiac event data sent to it, but performs various tasks without the need for a technician to receive, review, and interpret the data (such as the ECG data) before actively forwarding onto the respective health care provider, typically, a physician such as a cardiologist. The system thus eliminates the need for a technician, receiving and immediately sending the data to the physician who is best equipped to analyses, and interpret the data thus making informed medical decisions more timely and accurately.

As shown in FIG. 1, the patient platform is in communication with one or more physician interface devices 40 that could be tablets, smartphones, desktop computers, etc. The patient platform 12 also utilizes a database 42 for storing various databases needed to operate the platform.

Finally, the platform operates a website 44 that is regularly accessed by the various physicians as needed. The website presents on demand one or more web pages 46 that are patient specific. Initially these webpages 46 are used by physicians to register each patient on the platform 12 and set up some initial operational parameters, such specific cardiac signals of patients, alarm conditions, specific cardiac arrhythmias of interest and so on. Then, when the platform is in operation, webpages 46 specific to patients are generated and display current conditions of the patient of interest to the physician. For example, for a cardiac patient, the physician is presented with the latest cardiac parameters, an ECG profile, etc. The parameters displayed on the webpage are either obtained from the cardiac monitor device or, preferably are generated by the platform using data from the cardiac monitor device using the raw data from the cardiac monitor 14. Data either from the other respective monitoring devices 16-26 or derived from information from said devices is also presented to the physician on respective webpages 46. The physician then accesses this information from his interface 40.

The platform 12 communicates with each physician (as well as other designated recipients of alerts) by conventional means, such as phone, email, SMS or MMS messaging service, etc. In one embodiment, when appropriate, hot link is imbedded in a message from the platform to the physician device. The physician can select the hot link within the message and the physician device is automatically directed through this link to the relevant webpage 46.

In one embodiment, the system 10 further includes a videoconferencing module 50. A patient or a physician can request a video conference session through this module 50 and when the session is established the physician and the patient can talk to each other and discuss various issues related to the patient's health. In addition, the physician can request other parties, for example, a patient care taker (such as the patient's child) or a specialist to join the session. The module 50 is configured to make the necessary connections between the patient's tablet 14, the physician interface 40 and a third party to implement two or three way video conferencing even, if the third party is not a participant of the system.

The process for initiating and operating the system of FIG. 1 is now describe in conjunction with the flow chart of FIGS. 2 and 3. First, in step 100, each physician registers with the platform. As part of this process, he provides his personal information including address, insurance ID codes, practice type, etc. In step 102, one or more monitoring devices (including intermediate devices) are provided to the physician, each device having a unique ID that is recorded and associated with the respective physician, This information is stored in database 42. The devices are leased to the physician, or sold to him outright.

In step 104, a patient visiting the physician fills out some standardized forms providing personal information, medical history, known illnesses, allergies, medications, the regimen for the medications, etc. This information is provided to the physician (or, more properly, his staff) either manually or electronically.

Next, in step 106, the physician reviews the patient information, examines the patients and prescribes a treatment (if needed) and provides the patient with one or more monitoring devices, dependent on the condition of the patient. For example, for a cardiac patient, the doctor may prescribe certain drugs to be taken and provided with a tablet 28 and a cardiac monitor 14. The cardiac monitor 14 is set up by the physician to define what parameters are to be monitored. The tablet 28 is modified by the physician by activating on it the medicine management application 20. The patient is given instructions and training on how to use the devices.

In step 108, the physician uploads the personal information of the patient, together with information identifying the device(s) provided to the patient and the platform 12 establishes a record for each patient including:

Physician Information, email address and contact numbers to be used;

Patient demographic Information;

Specific monitor specifics established by the physician, i.e., if blood pressure results go above 160 or below 50, the Client/Provider is to be notified

Device Identification Information ID Number, etc.

The patient obtains the prescribed medicine and takes the device(s) received from the physician home. Once home, he activates the devices and in step 110 the devices establish communication with the platform 10 or with tablet 28 and go through an automated registration process at the end of which they are all set up and ready to record data, and the platform 10 is ready to receive data.

The operation of the system 10 is now described for different types of devices and patients. As a first example, monitoring of a cardiac patient is described.

As described above, preferably the cardiac event monitor 14 is off the shelf patented device. Interface to the monitor is established from the platform directly or through a tablet 28.

The device 14 comes installed with operating software that monitors the patient's heart and in one embodiment generates an alert once it detects certain abnormalities, such as arrhythmias. Such abnormalities are detected using conventional algorithms available for example from Monebo Technologies, Inc. of Austin Tex. The types of abnormalities and operational parameters are predetermined by the physician and entered in the platform 10 via web page 46. The platform then alerts the monitor device 14 to download settings corresponding to the parameters and used by the monitor device to detect such abnormalities, unless these parameters have already been entered by the physician.

As shown in FIG. 3, the patient's cardiac signals are obtained in step 120. In step 122 the signals are analyzed. The processing of the data is fully automated requiring no attendant or other human interaction, In step 124 the signals are analyzed to determine if they are within the normal value parameters established by the Physician at registration. If they are, the monitor 14 stores the data and no further action is necessary. If the data however is determined to be outside the normal parameters established by the physician the monitor then generates an alert in step 126 to the platform 12. The communications with the platform 12 include an ID of the monitor 14 so that the platform can immediately identify the monitor 14 and the associated patient since the monitor 14 is not operational until it is correctly registered and associated with a respective patient on platform 12

In essence, during step 124 a scrubbing process is performed during which data is “cleaned” so that data within the range described by the physician is saved but not presented to the physician until it is requested. At a later date, the physician, can access this data as discussed in more detail below, however, initially the physician is only notified of unusual events as defined by parameters provided with the respective devices and/or specified by the physician. In this manner, the physician is not swamped with excessive data descriptive of normal events.

During each event, data is collected by the monitor 14 defining a rhythm strip of the event, and including a predetermined pre event time period of about 15 seconds. The data is recorded until the event is completed or an event run time line predetermined and set at the time the patient is registered. The event data is then stored and transmitted to the platform 12 as required.

Returning to FIG. 3, when an abnormal event is detected, an alert is sent to the platform 12 in step 126 together with raw data describing the event, as well as other data showing cardiac activity for the last hour, day, week, etc.

In step 128, the platform 12 takes the raw data and transforms into one or more formats preferred by the physicians. FIGS. 4A-4C shows some possible graphs generated by the platform A. For example the graph of FIG. 4A shows a predetermined parameter, such as peak signal voltage at regular time intervals, FIG. 4B shows heart rate at different times. These graphs are presented on demand to the physician on a webpage 44. The physician can select any point on either graph, and an ECG (shown in FIG. 4C) is presented corresponding to the point selected by the physician.

Returning, to FIG. 3, in step 130 the platform 12 sends an alert to the physician indicating that a specific abnormality has been detected in a specific patient. The alert can be sent orally via telephone, by email, SMS, etc. The alert could also include some more information, such as a brief note of why the alert was generated and a hot link to the website on which the graphs 4A or 4B are found.

In step 132 the physician receives the alert and he can then decide to take any action on his own, without any input from the platform 12. Or the physician may access the website 46 and obtain a custom graph in step 134 as discussed above.

As discussed above, the platform 12 receives the raw event data and converts into a format that easily recognized by the physician, such as an ECG. In one embodiment, the platform generates a report including a report cover page with patient's demographic information and other basic rhythm interpretive information such as heart rate, whether the patient is in bradycardia, tachycardia, asystole and/or other abnormal events as defined by the algorithm used in the patient monitor device. The platform generates and incorporates other data into the report, such as a two dimensional graph representing the ECG. The report is stored for future reference and can be included with the alert to the physician (step 130).

Cardiac monitor 14 can be optionally patient activated. Should the patient desire for whatever reason perhaps is feeling sick, decides to activate a recording, there is a button on the front of the monitor for this purpose (not shown) that begins the same process used for recording and relaying the data to the monitoring platform which can handle this event in the same manner as an automated event. The difference is that in this latter case, the platform receiving the event data can indicate on the report that a particular event was a patient-activated rather than an automatically detected event.

All the data collected by the cardiac monitor 14 is transmitted to the platform 12 either directly from monitor 14 or by the physician when the cardiac monitor 14 is returned to the physician.

With the exception noted above, the patient monitor device is designed to require little patient interaction once installed. It is fully automatic from then on. The only instructions the patient needs is to:
1. Properly remove and apply the ECG adhesive electrodes as needed
2. Disconnect and reconnect the leads
3. Attach and remove the device for showering etc.
4. Provide familiarization with the display and its controls
5. Provide instructions for ICONs on the display, such as:
   loose lead wire
   Low battery, though the battery is designed to last up to 30 days
6. And finally the patient is provided a user brochure/booklet and a contact number at the provider office should they develop problems or have questions.

The process described above is similar to the processes used to obtain other data through the respective monitoring devices. As discussed above, preferably the monitoring devices have the capability to communicate with the platform 12 either directly or through the intermediate device 28. Of course, appropriate parameters are set for each of the devices. If a monitoring device does not have this capability then the intermediate device 28 is configured to allow a user to enter data from the device manually through an appropriate user interface. Typically, unlike the cardiac monitor 14, the other devices do not analyze the data for abnormal events, but merely upload the data to the platform 12, either as soon as a measurement is obtained, or at regular intervals. The analysis, data scrubbing, and alert generation are all performed by the platform 12.

As previously mentioned, some of the monitoring devices are implemented as applications on tablet 28. One such device is the medicine management device 20. As the patient signs up with the platform, he is asked to identify all the medicines he is taking, the dosage and the frequency. This data becomes part of the patient's profile. The patient can identify a drug by name or a standard NDL number. In a preferred embodiment, when the patient identifies one of his medicines, the platform retrieves a picture of the medicine, be it a tablet or a liquid in a bottle, and the picture is shown to the patient. The patient then has to confirm that the picture shows his medicine. If it does not, then the patient has to re-enter the name or code for his medicine.

Alternatively, the physician or the drug store provides the name and regimen for a medicine to the platform 12.

Importantly, the database 42 includes a cross-referenced listing of known medicine and adverse reactions to medicines when patients have certain conditions or when different medicines are taken together. For example, the listing may show that a patient with diabetes should not take certain medicine. As each medicine is entered into the profile of a patient, the platform 12 checks it against the listing. If a conflict is detected, either because of a condition of the patient or because of possible adverse reaction when one medicine is taken with another, the platform 12 alerts the physician. In one embodiment, the listing is found at a remote location, and the platform contacts the remote location to detect get access to the listing and detect conflicts.

In addition, medicine management device 20 also monitors whether the patient is taking his medicine in accordance with the stored regimen. (A version of this aspect of the invention is also described in co-pending US application Ser. No. 13/075,712) As shown in FIG. 5, this process may be implemented as follows. In step 150 the platform 12 determines that a patient should have taken a medicine at a certain time and a certain date and therefore within a short time thereafter, the platform contacts the patient. For the purposes of this discussion, this communication is described as being implemented by using standard telephones. Obviously other communication means such as emails maybe used as well.

In step 152, the platform 12 makes a call to the patient. In step 154 a determination is made as to whether the call was answered or not. If not, then the call is repeated several minutes later. If the call is answered, in step 156 a test is made to determine if an answering machine picked up the call. If yes, then a message is left to the patient that it is time to take his medicine (step 158) and the call is repeated at a later time. If a person answers in step 156 then in step 160 the patient has taken his medicine or not. If the patient reports that he has taken the medicine, then in step 162 a record is made of this event. In one embodiment, if the communication is taking place using email or other similar means, the patient can be assisted by transmitting to him a picture of the medicine that he is scheduled to take.

If he has taken the medicine, a record is made in step 162. If he has not taken the medicine he is asked in step 164 if he needs time but will take the medicine soon. If he agrees, then a record is made. If he does not indicate that he is going to take his medicine then in the next step 168, he is asked if he needs help. If not, a record is made in step 170 and another call is made to him later. If he says that he needs help then in step 172 the physician (or other care taker) is contacted and informed that the patient needs help with medicine.

In step 150 if the patient profile shows that the platform was unable to reach the patient within a predetermined time, an alarm is generated in step 174 and the physician and any other care taker are so notified. In an alternate embodiment, the patient provides several alternate phone numbers and all of them are contacted in sequence before raising an alarm.

In one embodiment, the patient either has his own smart device, such as smart phone, a tablet, etc, or is provided with a tablet and is more in control of what is going on. For this patient, once a regimen, for example for drug intake, is established, the tablet (or other patient device) receives a schedule corresponding to this regimen from the platform. The tablet then generates audio and/or visual reminders to the patient at appropriate times, for example, 30 minutes before a drug needs to be, 15 minutes before, etc. The patient is then expected to take the drug at the time and in the manner instructed and to either (a) confirm that he has taken the medicine on his device; (b) indicate that he has not taken the medicine; (c) enter some other information indicating he needs more time, or some other reason why he cannot take the medicine.

The platform 12 in this case does not send reminders initially to the patient, but instead sometimes after the drug was scheduled to be taken contacts the tablet automatically and queries the tablet as to whether the patient was properly reminded about the drug and whether the patient has responded to the reminder. If the patient has responded, the platform 12 records the response, and takes other action, if necessary. If the platform cannot get in touch with the tablet, or the tablet indicates that the patient has not responded to the reminders, then the platform attempts to contact the patient directly and get a response as described above. The platform 12 first calls the cell phone of the patient, the patient's home, the patient′ care taker in that order. The response obtained is recorded. If no response is received consistently the physician and other designated personnel may be notified.

It should be understood that somewhat similar processes may be used for sensing other events as well, such as taking a blood pressure reading, measuring weight, sugar level, EKG measurements, etc.

As discussed above, it is contemplated that one of the devices that can be provided to the patient is an A1CH sensor used to confirm or calibrate conventional sugar level measurements. Alternatively, under the direction of the platform 12, a kit is mailed to the patients at regular intervals (e.g., every 3 months) for measuring this parameter. The patient returns the kit with a blood sample to a lab. The lab makes the measurement and sends to the platform 12 for handling just like all the other measurements.

In one embodiment, the patient and physician designate several people for each type of alarm and the platform is configured to notify the respective people as designated. Preferably, if one of the designated people answers, it is assumed that he will handle the matter and therefore the remaining people on the list do not get a notification and the platform 12 resumes its normal operation. In another embodiment, the platform 12 sends a message to all the designated people listed for a particular patient so that all of them are aware that an event related to a particular patient has occurred. Depending on the desires of the physician and the severity of the event, in some instances one of the “people” receiving a notification may be a first responding entity such as an emergency team.

This same process is used for other monitoring devices as well where the monitoring devices need an action to be performed by the patient, such as the scale, the oxygenation level monitor device, the glucose level monitor, etc.

Other monitoring devices that could be incorporated as applications into the tablet, will operate in a similar way. For example, the tablet 28 may include an application for pain management. This application presents a human figure (optionally including a front and back side) to the patient. The patient is then prompted to select certain body parts either on touch screen or using a listing and indicate the relative pain level he feels in that particular body part. The responses are recorded and some predetermined rules are checked to determine whether an alarm condition should be declared. For example, the physician may require an alarm if a patient feels pain at the level of 3.0 (out of 4) in both ankles but no alarm is generated.

Other monitoring devices that are implemented on tablet include a mood monitor that prompts the client at regular interval to indicate what his mood was. Yet another device is a Parkinson monitor that prompts the patient to indicate the amount of trembling of his hand, etc.

Because of this commonality of processes for different modules of the system, the patient can learn how to use each one easily after he has received some basic training.

In one embodiment, the various applications are stored in the device 28 and are activated as needed by the physician remotely. In another embodiment, an application is downloaded to the tablet in response to a request by the physician.

The monitoring platform creates a patient record for every encounter and all health data collected through its monitoring devices is entered into this record. This electronic record is stored in the database 42 and can be accessed by physicians, provider networks and other health care professional when necessary for the purpose of providing a patient with continuous care if he changes physicians, moves, etc. The platform makes use of approved methods and processes to provide acceptable security levels (as described in more detail below), access to restrictions software, firewalls etc., and through sound management processes the issuing of access user names and passwords that meet Health Information Portability Accountability Act (HIPAA) compliance.

The physician normally access the platform 12 through web site 46 by providing his user name and password. Once he is signed, he can see various items, such as an inventory of monitoring devices he has in stock, as well as a list of his patients. Once he access the record for one of his patients, the patient's file window is opened and the physician can now access all stored data for the patient in database 42 through a menu called a “dashboard.” In this menu, the physician has various options to choose from, such as creating reports, graphs and downloading these reports and graphs such as the ones shown in FIGS. 4A, 4B, 4C. He can conduct review/analysis of all the data to look at patterns and trends, i.e., the physician can be provided a chart or list of results that include number of attempts to contact failures, how many times on average it took for this patient, the number of times patient failed to take his medications, the number of times the physician or alternate contacts office had to be contacted. (Some of the information, including for example the information related to the medicine is obtained from other devices associated with the patient). Thus the platform 12 provides a valuable means of display and printing off value mined data. The graphs can show the average number of failed or completed attempts at contacting the patients. It can provide information graphs on number of yes or no answers received by patient and how many times the alternate and/or physician had to be contacted for problems. This is valuable in demonstrating efficacy of the monitoring program in many ways, thus providing further documentation trail for use in any future Medicare/Medicaid reimbursement issues.

In one embodiment, the primary physician can sign on to his account using one of his devices and can select a so-called EZ Reader mode. In this mode, the platform maintains a record of when was the last time the physician has signed in to the system in this mode and what was the last patient event that he has reviewed. The system then presents recordings from the patients of the physician, one at a time, in chronological sequence. For example, if the physician is a cardiologist, he is presented with EKG's as they have been received from the different patients, one at a time. Preferably a portion of the EKG is automatically selected (e.g., a 60 second clip) and compressed so that it can be easily viewed by the physician. As the physician is presented with compressed clip, he is given the choice of accepting the clip, in which case the clip is stored with, and becomes part of the record for the patient, or archiving the clip, in which case the clip is stored and available for later review but is not made of the regular record for the patient. This latter choice may be selected, for example, if the physician decides that a particular clip was irregular or inaccurate. If a clip shows a dangerous condition, the physician can access the patient record and take immediate action.

Heart rate monitoring may be tailored for general or very specific patients. For example, the heart rate monitor may be used as part of a fetal monitoring system for high risk pregnancies. A separate sensor may also be used for this latter group to monitor premature contractions.

The patient monitoring platform protects patient information through a system of levels of accessibility by means of sound protective software and systems. A client/provider may have a need to share some data with other providers to meet continuity of care for their patients. The platform has the capability of allowing limited security levels of access to its clients that meets this need without compromising patient information security, as follows.

Level 5 is reserved for the corporate entity operating the platform and is assigned only to individuals with absolute need capabilities to access and manipulate collected patient health data and programming in all areas of control.

Level 4 is designated to a platform client, typically a physician who may possess a provider network and wishes to provide each of its health care providers in a specific region and/or location such as in the case of local or regional managed care networks to access to patient information stored within the system.

Level 3 is designated for physician with several patients. This level permits read/write controls for the operation of the patient monitoring devices.

Level 2 is designated for the physician office personnel. Data from the respective patients is available as read only data.

Level 1 is a read only mode for a specific patient to be shared with another provider.

When a physician accesses a patient profile from a dashboard, he is also presented with a QR code. He can capture this QR code with a portable device such as a smart phone, a tablet or other similar device using an application such as SCAN LIFE. Once decrypted by the portable device, the QR code causes predetermined patient specific information to be downloaded to the physician's device such as the patient's latest vital signs (e.g., weight, blood pressure heart rate, medications he is taking, compliance or non-compliance with his medicine regimen, etc.)

Similar information may also be shared by the physician with another physician by sending a token from the dashboard. The token be imbedded in an email that provides instructions for its used. Once the token is received, the second physician will have access to the profile of a specific patient. The access is preferably limited several ways. It may be Read Only so that the second physician cannot alter the patient profile. The token may expire in a number of days. In one embodiment, the primary physician is given the choice of issuing a token that expires anywhere from one to 15 days. Finally, the token may limit how many times the patient profile can be accessed by the second physician (e.g., seven times).

In one embodiment, a patient can access the platform, and receive limited rights to obtain a designated part of his record, such as vital statistics, immediate past history, latest parameters, etc. Importantly, the patient does not have the rights to modify or any information on his record. However, now that he has this information in his tablet, he can go to another doctor or hospital for regular or emergency care, and provide a lot of information required for his treatment from his tablet.

One feature provided on the website to a physician is inventory control. While this function may be implemented by software on platform 12, it is represented in FIG. 1 by discrete inventory module 48. This module may be used to keep track of devices and other materials provided to the physician (e.g., the number of devices provided to the physician, the number of devices idle, the number of devices currently in use, etc.) or can be expanded to the physician's patients, in which case some of the functions of the tablet 28 are also coupled to inventory control. For example, inventory module 48 can receive a notification every time a specific patient receives a medicine or some other supplies and every time an event takes place that affects that medicine or other supply. Then, each time an event is reported to the platform 12 that is associated with a patient and his supplies, the inventory module makes an appropriate entry. The inventory module then determines at regular intervals whether certain medicines and supplies have been almost used up and a reminder is then sent by the platform 12 to the patient that he may need to order the same.

In some instances, a more complex process is implemented for inventory control, that involves a determination as to whether a supply needs to be replaced or not. For example, patients suffering from sleep apnea are provided with a mask that needs to be replaced at regular intervals. Therefore, after a predetermined period of time, based on information from the inventory module 48 a message is sent to the patient with a picture of a used filter that is in need of replacement and the patient is then asked to compare his mask to the pictured mask. The patient can then indicate whether his mask looks like the used mask from the picture or not. This process not only facilitates the patient's decision as to whether he should replace the mask or not but also prevents fraudulent transactions.

The tablet 28 being provided to patients may be based on a well known platform, including Microsoft, Android or Apple. Normally it is configured so that it provides access to a limited number functions defined by the physician before the tablet is turned over to the patient. These functions are primarily related to the patient condition(s) being monitored. However, if the tablet is capable of it, it can perform other, somewhat auxiliary functions as well. The following is at least a partial listing of the functions potentially available on the tablet. At least some of these functions are implemented using applications installed on the table.
1. Diabetic Glucose Monitoring
2. Blood Pressure Monitoring
3. Pulse Oxygen Saturation
4. Medication Management
5. Weight Monitoring
6. PTI/NR Testing
7. Cardiology
8. Sleep Apnea
9. Pain management
10. Physical conditions related to Parkinson and other diseases
11. Psychological monitoring
12. Pregnancy monitoring
13. AudioNisual conferencing via Cellular technology
14. Wi Fi Internet Access
15. Telephone Use Capability
16. Emergency (911) on button touch launches automatic dialing to emergency services and other contacts chosen by the patient at registration, i.e., such as their spouse, son or daughter and of course their patient physician.
17. Ability to tie in patient managed care network access by patient information assistance and other matters such as billing etc,
18. A program that allows for downloading of teaching material beneficial to patients health education as well as specific visual instructions on how to use specific monitoring devices provided to the patient.

The present invention provides several improvements over prior art systems, such as the elimination of the need for a technician monitoring and handling, which decreases cost, reduces the time required to analyze the data, transmit it to the physician (preferably after scrubbing) and allow abnormal event data to be interpreted by the patients physician. Moreover, the data is transmitted to the physician as fast as possible and the sooner the physician receives data the faster he can act on it. In this manner the system insures that the patient's condition is reviewed by and acted on by his physician as fast as possible with no intermediate parties involved.

Obviously numerous modifications can be made to this invention without departing from its scope as defined in the appended claims.

I claim:

1. A patient monitoring system for monitoring various parameters associated with the health of the patients, each patient being associated with one or more monitors measuring the parameters of interest for that patient and each patient being under the supervision of a primary physician, said system comprising:
a platform automatically communicating with all the monitors of all the patients at regular intervals to receive information indicative of said parameters, said platform being configured to analyze said information, determine if said parameters meet a predetermined criteria set by the respective primary physician of the respective patient, and selectively generate an alert based on said analysis; and
a physician interface selectively accessed by physicians to obtain information about their patients.

2. The system of claim 1 wherein at least some patients are further associated with an intermediate device, said intermediate device selectively communicating with monitoring devices associated with the respective patients, said platform being configured to receive information through said intermediate device.

3. The system of claim 2 wherein said intermediate device is a tablet.

4. The system of claim 2 wherein said platform is configured to generate a regimen for each patient for obtaining said parameters or take medicine, said platform being further adapted to contact said patients to determine if said patients have complied with said regimen, and to generate alerts to the physicians if there is lack of compliance by some patients.

5. The system of claim 4 wherein said platform is configured to send queries to said intermediate device to determine compliance.

6. The system of claim 1 wherein said platform is further coupled to a website and is configured to send alerts to said physicians, said alerts including imbedded links to said website for accessing patient information.

7. The system of claim 1 wherein said physician interface is adapted to provide patient parameters obtained from a plurality of said patients in sequence when requested by a physician associated with said patients, said patient parameters being presented in chronological order.

8. The system of claim 7 wherein said parameters include EKGs.

9. The system of claim 8 wherein said EKGs are presented as a compressed graphic display.

10. A patient monitoring system for monitoring various parameters associated with the health of the patients comprising:
a plurality of monitoring devices configured to monitor a parameter indicative of a patient's biological or psychological function or a drug intake by the patient, each patient being associated with one or more monitoring devices, each patient being under the supervision of a primary physician, each monitoring device receiving a respective monitoring input indicative of the respective parameter and selectively generating an output based on said input;
a platform automatically communicating with all the monitoring devices of all the patients to receive said inputs indicative of said parameters, said platform being configured to analyze said information, determine if said parameters meet a predetermined criteria set by the respective primary physician of the respective patient, and selectively generate an alert based on said analysis; and
a physician interface selectively accessed by physicians to obtain information about their patients.

11. The system of claim 10 further comprising intermediate devices associated with some of said patient and receiving an intermediate input from the respective patient or from one of said monitoring devices.

12. The system of claim 11 wherein said platform is configured to query said intermediate device to obtain information about the patient.

13. The system of claim 10 wherein said platform is configured to present to each physician information about the patients being handled by the respective physician on a webpage.

14. The system of claim 10 further comprising a database containing information about interactions between different drugs prescribed to patients, wherein said platform is configured to receive drug prescriptions for a patient and to check with said database to determine for each new drug whether said new drug will interact with another drug prescribed for that patient.
